(19) United States
(12) Patent Application Publication
(10) Pub. No.: US 2002/0015015 A1
(43) Pub. Date: Feb. 7, 2002

(54) Matrix driving schemes for cholesteric liquid crystal displays

(76) Inventors: Steve Wai Leung, Tseung Kwan O (HK); Richard C.H. Lee, Tseung Kwan O (HK); Berry S.K. Lam, Tseung Kwan O (HK); C.C. Leung, Tseung Kwan (HK); Patrick P.C. Lo, Tseung Kwan O (HK); M.T. Yeung, Tseung Kwan O (HK)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/847,570

(22) Filed: May 2, 2001

(30) Foreign Application Priority Data
May 4, 2000 (GB) 0010825.8

(51) Int. Cl. G09G 3/36

(52) U.S. Cl. 345/87

(57) ABSTRACT

The invention relates to a method of driving an LCD, comprising providing an array of pixels, characterised by the steps of providing cholesteric liquid crystals arranged between spaced transparent substrates, and by providing a reset pulse and a plurality of selection pulses whereby to provide resultant driving waveform(s).

Thus the driving schemes or methods shown consist of a reset phase and a selection phase, the pulses of the latter being equipped with freedom in the multiplicity of the selection pulses. These schemes provide gray scale capability and improved optional performance. Inversions of waveform are used.

The invention relates to matrix addressing schemes and driving waveforms for gray scale color cholesteric liquid crystal displays which retain the image pattern in the absence of an applied electric field.

Classical liquid crystal displays require the use of polarizers resulting in low brightness, particularly in outdoor applications, and severe viewing angle dependence. Backlight is needed and hence a tremendous power consumption. There has been recently active research in cholesteric liquid crystals (ChLCs) in the last two decades. ChLCs have the properties of bistability of micro-domain structures and adjustable reflectivity against wavelengths. Desirable properties of ChLC displays are image retention, very low power consumption, tunable monochrome and multi colors, gray scale capability, wide operating temperature range and excellent viewing angles. The two bistable domain structures are planar states (the molecules are aligned helically with the helical axes oriented in the same direction) and micro-domain focal conic states (each micro-domain consists of helix structure and the helical axes of the domains are aligned multi-directionally). The directions of the helix can be controlled electrically. The helices reflect a certain circular polarization (left hand or right hand) at a pre-selected wavelength spectrum. The peak λ of the reflectivity spectrum is dependent on the average refractive index n and the pitch p of the ChLC, namely λ=nxp. The pitch of the ChLC and so the peak of the spectrum can be adjusted by the amount of chiral dopant added in the twisted nematic fluid. When the ChLCs are contained in two parallel transparent substrates, a reflective bright color (when the helical axes in the planar state are perpendicular to the substrate surfaces) and a weakly light scattering transparent appearance (when the helical axes of the focal conic micro-domains are parallel to the substrate surfaces) can be seen. When the bottom substrate is printed black, focal conic state appears dark. The planar ON and focal conic OFF states can be produced. Gray scale can also be generated by controlling the proportion of the planar state and focal conic state in the liquid crystal. This can be accomplished by applying electrical signals of suitable voltage levels. These planar and focal conic micro-structures are stable even in the absence of electric field. As a consequence, energy is only needed in changing the image pattern of the display and resulting in very low power consumption.

When a potential difference is applied to the common electrode and the segment electrode of a pixel, the effective voltage is the difference between the common and the segment electrode, namely

V_{effective}=V_{common}−V_{segment}

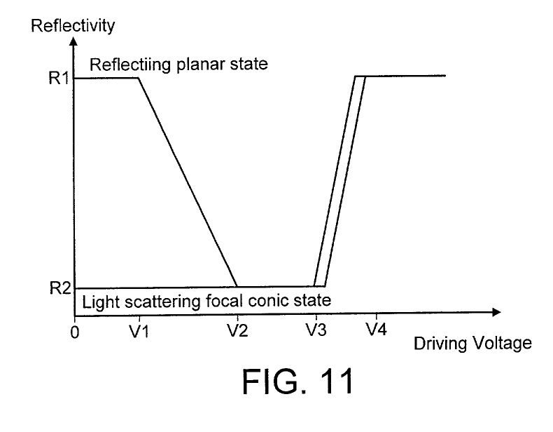

Thus that the voltages of common and segment electrodes are polar but the effective voltage can be bipolar. However, the liquid crystal molecules react in the same fashion for positive voltages and negative voltages. To generate a negative effective voltage from polar common and segment voltages, an appropriate DC offset can be added to both the common electrode and segment electrode so that the resultant common voltage and segment voltage are polar. Negative pulses of all inversion schemes can be implemented this way. A typical reflectivity/driving voltage graph for a given ChLC upon a voltage pulse is shown in FIG. 11.

The values V1, V2, V3, V4, R1 and R2 of FIG. 11 depend on the time duration and the amplitude of the driving pulses. For any given time duration, the reflectivity is substantially unchanged when the driving voltage is less than the threshold voltage V1. This threshold voltage V1 is given by the formula

$$V1 = {π}^{2} \sqrt{\frac{{K}_{22}}{{ϵ}_{0} Δϵ}} \frac{d}{p} .$$

By adjusting the concentrations of the chiral dopants, red, green and blue colors single layers can be obtained. A full color display is achieved by stacking the RGB (red, green, blue) layers. For a full color application, the d/p ratio of red, green and blue are chosen to be the same and are between 10 and 15 so that the driving waveforms are similar for the three colors and the reflectivity is big enough.

According to the invention there is provided a method of driving an LCD comprising providing an array of pixels, characterised by the steps of providing cholesteric liquid crystals arranged between spaced transparent substrates, and by providing a reset pulse and a plurality of selection pulses whereby to provide resultant driving waveform(s).

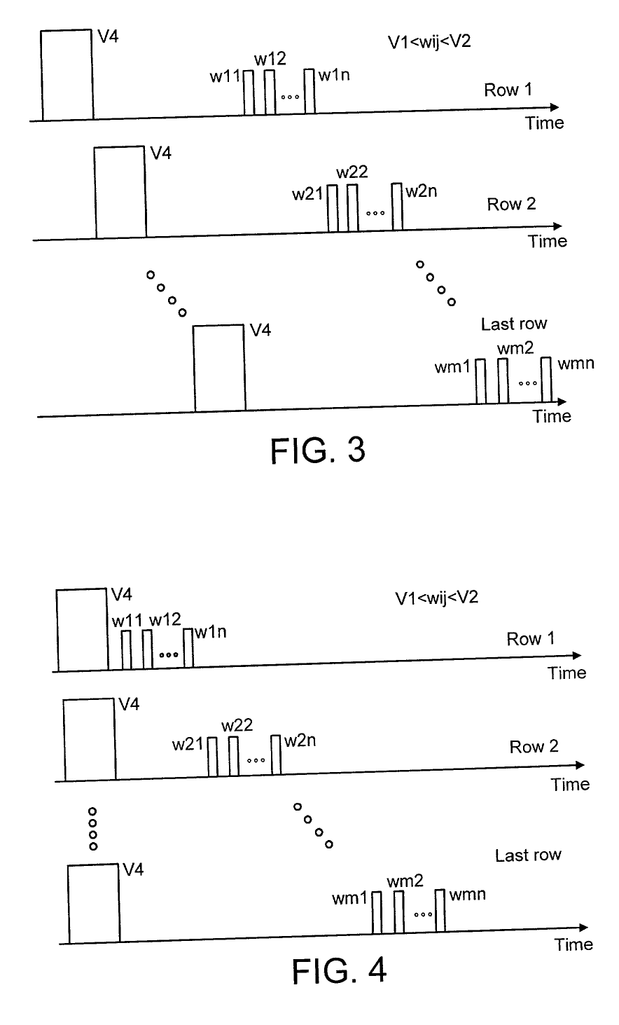

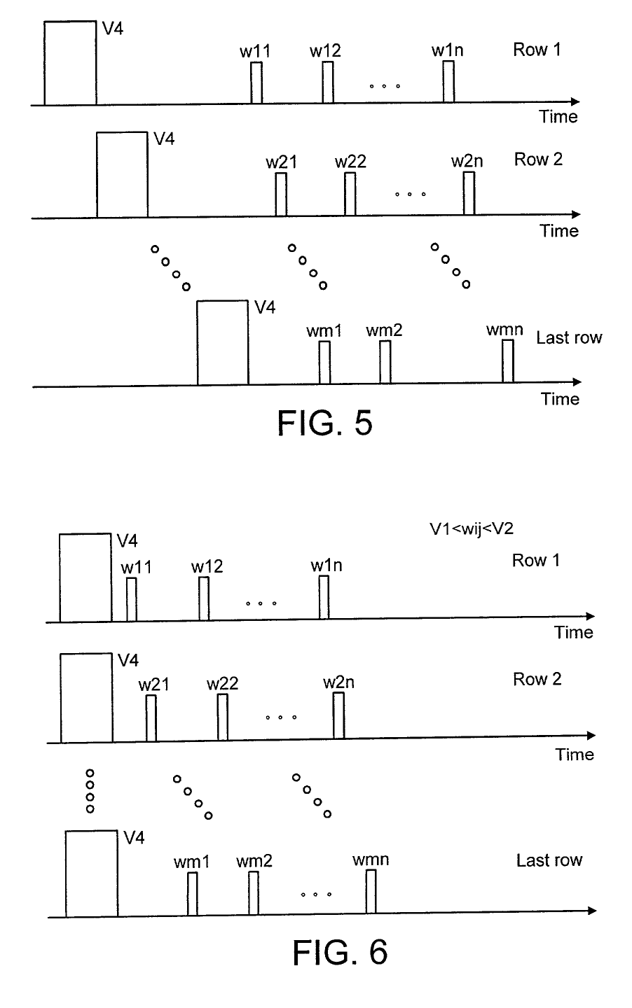

Using the invention it is possible to provide a ChLC (cholesteric liquid crystal) display driving waveforms (the effective voltages experienced by the liquid crystal molecules) giving much improved dark state and larger freedom in gray scale generation. This driving waveform thus may consist of a reset pulse and a plurality or number of amplitude modulated selection pulses. The voltage level of the multiple selection pulses can be different from each other. Suitably the number of selection pulses and the voltage of each selection pulse are chosen so as to have (i) a darker focal conic state and (ii) greater freedom in gray scale. The voltages of the pulses are determined based on the experimental intrinsic reflectivity property (see FIG. 11). In multiplex addressing, the reset pulses V4 can be arranged in a non-pipeline manner (e.g. FIG. 3), a pipeline manner (e.g. FIG. 4) or any combination of both. For the non-pipeline waveform, a scanning line refreshing the whole display into a bright planar state is observed whereas in the pipeline waveform, the whole display is refreshed simultaneously. On the other hand, the multiple selection pulses W11−W1n, W21 −W2n, etc can be arranged in a cluster way (see FIG. 3), interleaved with other rows (see FIG. 5) or any combination of both. For the cluster selection pulses method, the scanning lines are swept from the first row and sharp patterns appear after the row is scanned. For the interleaving selection pulses method, a coarse image is formed and is gradually enhanced to a fine and sharp image when more scanning lines are swept. This new degrees of freedom in the number of multiple selection pulses and their amplitudes are particularly useful in reducing the haze in the OFF focal conic state. Gray scale is obtained by selecting the number of pulses in the selection phase and the voltages of the multiple selection pulses. The absolute values of the voltages of the multiple selection pulses are between V1 and V2 according to the reflectivity property of the cholesteric liquid crystals given in Figure 11. The larger the voltages of the multiple selection pulses, the more focal conic the domain structures and hence the darker the resulting pixel. On the contrary, the smaller the voltages of the multiple selection pulses, the more planar state the domains and hence the brighter and more reflecting are the resulting pixel. Gray scale is obtained by adjusting the intermediate voltage levels of the multiple selection pulses.

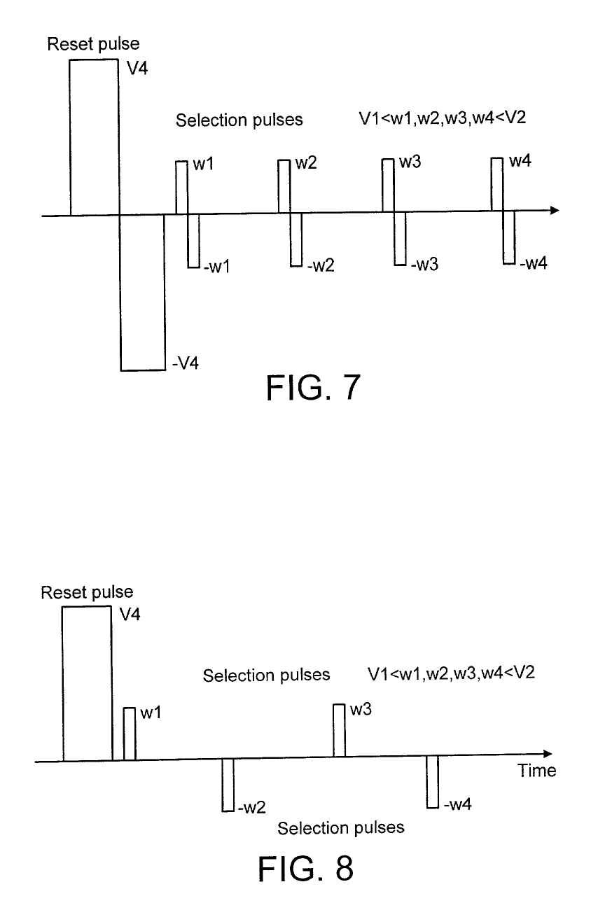

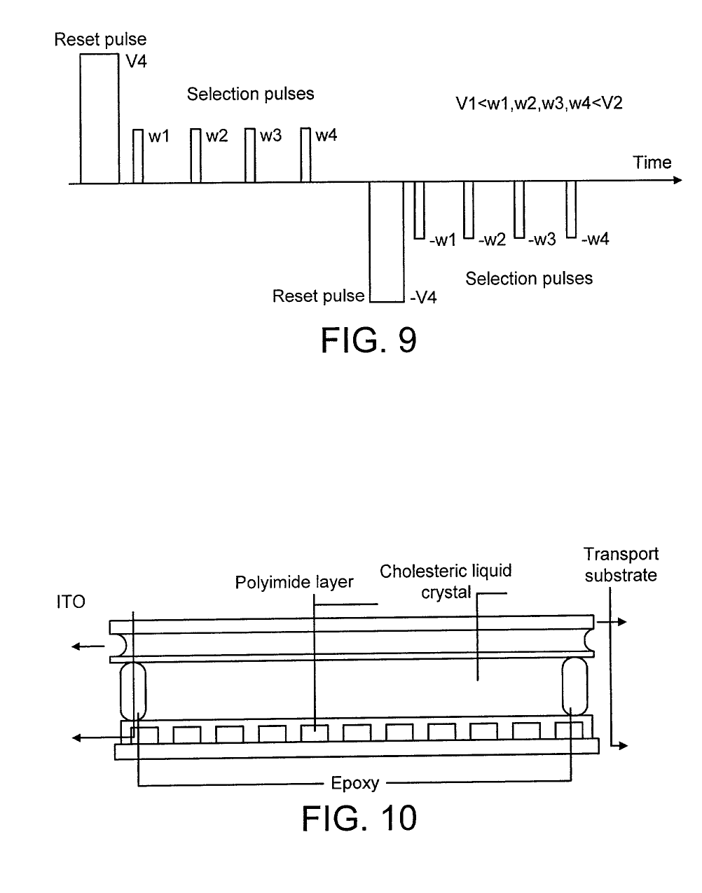

Another feature of a method embodying the invention is the various ways of waveform polarity inversion. Three basic principles are proposed. They are (i) immediate polarity inversion after each pulse (e.g. see FIG. 7); (ii) some pulses in the frame period are polarity inversed (e.g. see FIG. 8); and (iii) polarity inversion by the next frame period (e.g. see FIG. 9). A combination of these three principles is possible. For example, a combination of the first two can be like this: the reset pulse has immediate polarity inversion immediate after itself and half of the multiple selection pulses are of positive polarity and the other half are of negative polarity. Negative pulses can be produced by using small positive common signals and large positive segment signals. These waveforms are obtained by adding appropriate DC offset to common and segment signals.

A method embodying the invention is hereinafter described, by way of example, with reference to the accompanying Figures.

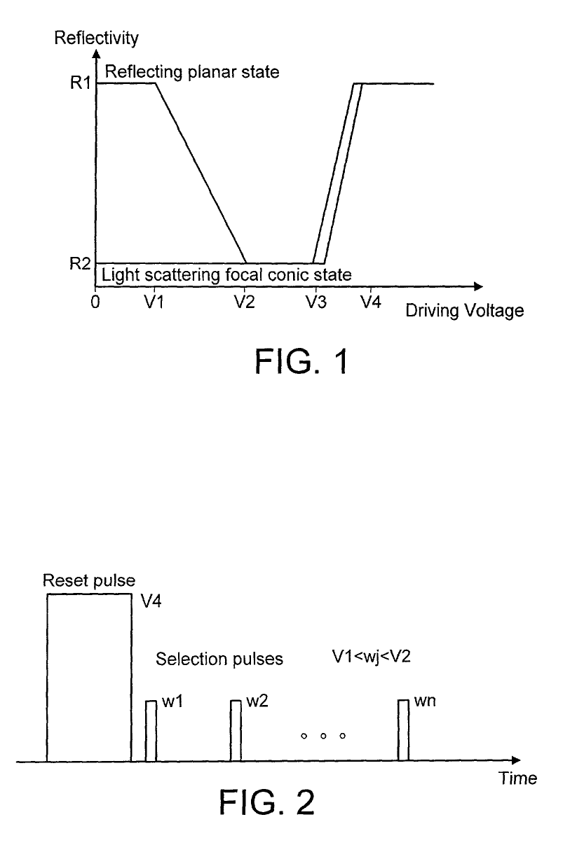

FIG. 1 is a graph illustrating the reflectivity property for cholesteric displays when an electrical pulse is applied to an initial bright reflecting planar state and an initial dark weakly light scattering focal conic state.

FIG. 2 is a single line driving waveform consisting of a high reset pulse and medium level multiple amplitude modulated selection pulses of variable voltage levels and under no inversion. The voltage of the multiple selection pulses may be different from each other.

FIG. 3 shows multiplexed driving waveforms consisting of a plurality of waveforms. Each waveform is composed of a high reset pulse and clustered medium level multiple amplitude modulated selection pulses of variable voltage levels and under no inversion. The reset pulses and the multiple selection pulses of the waveforms are in a non-pipeline fashion.

FIG. 4 shows multiplexed driving waveforms consisting of a plurality of waveforms. Each waveform is composed of a high reset pulse and clustered medium level multiple amplitude modulated selection pulses of variable voltage levels and under no inversion. The reset pulses are arranged in a pipeline fashion and the multiple selection pulses are arranged in a non-pipeline fashion.

FIG. 5 shows multiplexed driving waveforms consisting of a plurality of waveforms. Each waveform is composed of a high reset pulse and interleaved medium level multiple amplitude modulated selection pulses of variable voltage levels and under no inversion. The reset pulses and the multiple selection pulses of the waveforms are in a non-pipeline fashion.

FIG. 6 shows multiplexed driving waveforms consisting of a plurality of waveforms. Each waveform is composed of a high reset pulse and interleaved medium level multiple amplitude modulated selection pulses of variable voltage levels and under no inversion. The reset pulses are arranged in a pipeline fashion and the multiple selection pulses are arranged in a non-pipeline fashion.

FIG. 7 is a single line driving waveform consisting of a high reset pulse with inversion and medium level multiple amplitude modulated selection pulses with inversion of variable voltage levels. Each of the reset pulse and selection pulse has inversion immediately after the pulse itself.

FIG. 8 is a single line driving waveform consisting of a high reset pulse and medium level multiple amplitude modulated selection pulses of variable voltage levels. Some of the multiple selection pulses are taken to be of opposite polarity.

FIG. 9 is a single line driving waveform consisting of two frame periods. Each of the frame periods is composed of a high reset pulse and medium level multiple amplitude modulated selection pulses of variable voltage levels. The reset pulse and the multiple selection pulses of the adjacent frame period are taken to be of opposite polarity.

FIG. 10 is a cross section of a simplified single layer cholesteric display consisting of two transparent substrates. On the inner surfaces of each transparent substrate, transparent indium tin oxide (ITO) electrodes are coated in arrays and a polyimide layer is coated on top of the ITO electrodes. A cavity containing cholesteric liquid crystals is located between these two surfaces and with epoxy sealed at the perimeter of the display.

FIG. 11 is a single line waveform showing the reflectivity of a cholesteric liquid crystal display against voltage of a driving pulse.

It will be understood that the term “pipelining” or the like used herein refers to an overlap of pulses. Stated in another way pulses occur simultaneously.

In FIG. 3 there is shown schematically an example of non-pipeline reset pulses V and non-pipeline clustered multiple selection pulses W, multiplexed waveform.

In FIG. 4 there is shown schematically an example of pipeline reset pulses V and non-pipeline clustered multiple selection pulses W, multiplexed waveform.

In FIG. 5 there is shown schematically an example of non-pipeline reset pulses V and non-pipeline interleaved multiple selection pulses W, multiplexed waveform, where V1<wij<V2.

In FIG. 6 there is shown schematically an example of pipeline reset pulses V and non-pipeline interleaved multiple selection pulses ”, multiplexed waveform.

In FIG. 7 there is shown an example of multiple selection pulses V and −V with inversion immediately after each pulse.

In FIG. 8 there is shown schematically an example of multiple selection pulses V and −V with polarity inversed by other pulses ”, −W in the same frame period.

In FIG. 9 there is shown schematically an example of multiple selection pulses V, −V with inversion in the next or a subsequent frame period.

Advantages of embodiments of the invention as shown in the Figures are set out below.

1. A driving method, with the resultant driving waveform consisting of a high reset pulse and multiple selection pulses of variable amplitudes of determined pulse width, for an array of pixels arranged in a plurality of rows and a plurality of columns in which cholesteric liquid crystals re filled between two transparent substrates. The voltage levels of all pulses in the driving waveform are determined by the pulse width and the reflectivity property of the cholesteric liquid crystal (e.g. see FIG. 11).

2. The reset pulses of the multiplex addressing driving waveforms given above can be arranged in a pipeline, non-pipeline manners or partial rows pipelined and partial rows non-pipelined (e.g. see FIG. 3, FIG. 4, FIG. 5 and FIG. 6). The voltages of the reset pulses are larger or equal to the reset voltage given by the reflective property of the cholesteric liquid crystal (i.e. V4 of FIG. 11).

3. The multiple selection pulses of the multiplex addressing driving waveform can be arranged by clustering together (e.g. see FIG. 3 and FIG. 4), by interleaving with the other rows (e.g. see FIG. 5 and FIG. 6), or any combination of both. The voltages of the multiple selection pulses have the absolute values between the threshold voltage and the voltage of minimum reflectivity given by the reflectivity property of the liquid crystal (e.g. VI and V2 of FIG. 11).

4. The driving waveforms may be modified with immediate polarity inversion after each pulse in the driving waveform. Immediate following each pulse in the frame period, an opposite polarity but of same magnitude is added. An example can be seen in FIG. 7.

5. The driving waveforms may be modified with some of the pulses, including the reset pulse and the multiple selection pulses, in the frame period are polarity inversed. An example can be seen in FIG. 8.

6. The driving waveforms may be modified with polarities of the pulses in the next frame is opposite to the present one. The arrangement of the multiple selection pulses of the next frame period may be different from the present one. An example can be seen in FIG. 9.

7. The driving common waveforms can be modified by a combination of the driving waveforms above.

8. Gray scale is generated by adjusting appropriate voltage levels of the multiple selection pulse in the waveforms given above. The gray level is determined by the voltage levels having absolute values between the threshold voltage and the voltage of minimum reflectivity with respect to the reflectivity property of the cholesteric liquid crystal (e.g. see FIG. 11

We claim:

1. A method of driving an LCD, comprising
(i) providing an array of pixels;
(ii) by the steps of providing cholesteric liquid crystals arranged between spaced transparent substrates; and
(iii) by providing a reset pulse and a plurality of selection pulses whereby to provide resultant driving waveform(s).

2. A method as defined in claim 1, wherein the selection pulses comprise amplitude modulated selection pulses.

3. A method as defined in claim 2, wherein the selection pulses are multiple selection pulses of variable amplitudes of determined pulse width.

4. A method as defined in claim 1, wherein there is a multiplex addressing driving waveform and a reset pulse selected from a group consisting of a pipeline and non-pipeline arrangement.

5. A method as defined in claim 4, wherein partial rows are pipelined.

6. A method as defined in claim 4, wherein partial rows are non-pipelined.

7. A method as defined in claim 1, wherein voltages of the reset pulses are at least no smaller in value than the reset voltage provided by the reflective property cholesteric liquid crystal.

8. A method as defined in claim 7, wherein the reset pulses are greater than the reset voltage.

9. A method as defined in claim 1, wherein the selection pulses of the multiplex driving waveform are arranged in groups selected from clustering together, interleaving with other rows, and a combination of said clustering and said interleaving.

10. A method as defined in claim 9, wherein the voltages of the selection pulses have absolute values between the threshold voltage and the voltage of the property of minimum reflectivity of the liquid crystal.

11. A method as defined in claim 1, wherein the driving waveform(s) have instantaneous polarity inversion after each pulse in the driving waveform.

12. A method as defined in claim 11, wherein an opposite polarity of equal magnitude is added to each pulse in the frame period.

13. A method as defined in claim 1, wherein at least some of the pulses of the driving waveform are polarity reversed in the frame period.

14. A method as defined in claim 1, wherein the polarity of a succeeding pulse of the driving waveform is opposite the polarity of the immediately preceding (instant) pulse.

15. A method as defined in claim 14, wherein the arrangement of the multiple selection pulses of a succeeding frame period is different from the instant pulse.

16. A method as defined in claims 13 and claim 14 wherein there is a common driving waveform comprising a combination of said waveforms.

17. A method as defined in claim 1, wherein there is a gray scale generated by adjusting appropriate voltage levels of the multiple selection pulse of said waveform(s).

18. A method as defined in claim 17, wherein the gray level is determined by respective voltage levels having absolute values between the threshold voltage and the voltage of minimum reflectivity with respect to the reflectivity property of the cholesteric liquid crystal.

19. A method as defined in claim 1, wherein the voltage level of all pulses in the driving waveform(s) is determined by the pulse width of reflectivity property of the cholesteric liquid crystal.
